(19) United States
(12) Patent Application Publication
(10) Pub. No.: US 2013/0282729 A1
(43) Pub. Date: Oct. 24, 2013

(54) INTELLIGENT HIGHLIGHTING SYSTEM

(71) Applicant: Michael J. Fisher, Hamburg (DE)

(72) Inventor: Michael J. Fisher, Hamburg (DE)

(21) Appl. No.: 13/869,711

(22) Filed: Apr. 24, 2013

Related U.S. Application Data
(60) Provisional application No. 61/637,720, filed on Apr. 24, 2012.

(51) Int. Cl. G06F 17/27

(52) U.S. Cl. CPC G06F 17/2705
USPC 707/741

(57) ABSTRACT

An intelligent highlighting system for automatically determining where the author has marked a manuscript for insertion of multimedia, and then inserting the multimedia into digital publications is provided. In the system, digital publication are parsed to identify multimedia references, such as footnotes, comments and hyperlinks. A database table index containing the parsed results is generated and stored in a projected identification database. Next, metadata specific to the parsing results are also stored in the project identification database and a pre-determined highlighting method is identified. The metadata and highlighting method are compiled into an intelligent highlighting object, which is used to embed a hidden multimedia path within the keywords. The keywords with the embedded multimedia are then stored as a binary file. Using the data stored in the project identification database, the binary file and e-reader specifications, the multimedia files are converted to the appropriate format compatible with the e-readers.

### CLAIM OF PRIORITY UNDER 35 U.S.C. §119

The present Utility Application for Patent claims priority to U.S. Provisional Application No. 61/637,720 entitled “Intelligent Highlight System” filed Apr. 24, 2012, and hereby expressly incorporated by reference herein.

### FIELD OF INVENTION

Aspects of the present disclosure relate generally to digital publications, and more particularly, to automated assembly of multimedia enhanced digital publications, embedded programmable objects, and automated production of multiple versions of the enhanced digital publications compatible with multiple electronic reader platforms.

### BACKGROUND OF INVENTION

The publishing industry is undergoing historic changes as a result of the advent of digital multimedia displacing print publications. The availability of what are known as electronic books (or e-books) surpassed the number of paperback print books published in the United States in 2011. Over 80 percent (80%) of all e-books currently in circulation were published by the top ten publishers in the world. Moreover these e-books produced for the top publishers were produced manually, by offshore outsourcing providers predominantly based in India. Currently the top ten publishers occupy all such outsourced resources, leaving smaller publishers, self-publishers, and independent writers with few alternatives. The lack of alternative e-book production services has created a bottleneck in the industry, which threatens further market growth.

The availability of various devices by which to read e-books has also affected the publishing industry. What are referred to as e-readers were first introduced by online retailers, such as Amazon® (Kindle®) and Barnes & Noble® (Nook®). More sophisticated multipurpose devices continue to encourage publishers and the authors to create multimedia enhanced publications. Products such as Apple's iPad®, with its capacity to play music and video files (“media” or “multimedia” as herein defined), provide for an entirely new reading experience. Additionally, digital publications can be shared by posting excerpts on the Internet. Such capabilities pave the way for sharing books in a unique way. For example, many publishers are now posting digital teasers in order to promote print book sales.

In view of the high demand for digital publications and the increasing sophistication of e-readers, a system and method for automatically inserting multimedia into digital content, such as digital publications, is needed.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspect of the disclosure. Its sole purpose is to present some concepts of one or more aspects of the disclosure in a simplified form as a prelude to the more detailed description that is presented later.

In one aspect, the disclosure provides method of automatically determining where an author has marked a manuscript, or a digital publication, for inserting multimedia. The present disclosure also allows the author to control how the reader is made aware of the presence of multimedia, how the multimedia is accessed, and whether the multimedia displays or plays automatically.

The method includes parsing the digital publication to identify multimedia references within the digital publication; indexing locations and reference data associated with the multimedia references identified in the digital publication; identifying and categorizing the indexed locations and the indexed reference data, where the indexed, identified and categorized locations and reference data used to identify and capture multimedia; and storing the indexed, identified and categorized locations and reference data in a project identification database.

The method may further include locating metadata stored in a metadata database; storing the metadata in the project identification database; executing a pre-determined highlighting method used to highlight one or more keywords where the one or more keywords identified by the multimedia references; compiling the metadata and the pre-determined highlighting method as an intelligent highlighting object; and storing the compiled metadata and pre-determined highlighting method as a binary file.

Additionally, the method may include determining specifications of one or more electronic reading devices, the specifications including one or more formats compatible with the one or more electronic reading devices; converting the multimedia file to one or more formats compatible with the one or more electronic reading devices; automatically highlighting the one or more keywords with the intelligent highlighting object; and embedding a hidden multimedia path within the one or more keywords.

The multimedia references may include at least one of a footnote, comment and hyperlink; and the reference data may be selected from at least one of online multimedia and offline multimedia, wherein the online multimedia is may be URL and the offline multimedia may be a multimedia extension. The metadata may include at least one of a title, an author's name, an International Standard Book Number (ISBN), a copyright date, and information of where to purchase the publication. The pre-determined highlighting method may be a cosmetic highlighting method for changing an appearance of the one or more keywords or an intelligent highlighting method, the intelligent highlighting method provides a visual alert.

In another aspect, a system for automatically inserting multimedia files into a digital publication is provided. The system may include at least one processor; a project identification database coupled to the at least one processor; and a metadata database coupled to the at least one processor. The at least one processor may be configured to parse the digital publication to identify multimedia references within the digital publication; index locations and reference data associated with the multimedia references identified in the digital publication; identify and categorize the indexed locations and the indexed reference data, where the indexed, identified and categorized locations and reference data used to identify and capture multimedia; and store the indexed, identified and categorized locations and reference data in the project identification database.

The at least one processor may be further configured to locate metadata stored in a metadata database; store the metadata in the project identification database; execute a pre-determined highlighting method used to highlight one or more keywords, the pre-determined highlighting method stored in the project identification database and the one or more keywords identified by the multimedia references; compile the metadata and the pre-determined highlighting method as an intelligent highlighting object; and store the compiled metadata and pre-determined highlighting method as a binary file.

The at least one processor may also be configured to determine specifications of one or more electronic reading devices, where the specifications include one or more formats compatible with the one or more electronic reading devices; convert the multimedia file to one or more formats compatible with the one or more electronic reading devices; automatically highlighting the one or more keywords with the intelligent highlighting object; and embed a hidden multimedia path within the one or more keywords.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating a general overview of an Intelligent Highlighting System according to one aspect.

FIG. 2 is a block diagram illustrating a general overview of parsing uploaded content, according to one aspect.

FIG. 3 is a block diagram illustrating a general overview of communications between the highlight processor and the metadata database, according to one aspect.

FIG. 4 is a block diagram illustrating a general overview of communications between the highlight processor and the highlight database, according to one aspect.

FIG. 5 is a block diagram illustrating a general overview of communications between the highlight processor and the object engine, according to one aspect.

FIG. 6 is a block diagram illustrating a general overview of communications between the highlight processor and the platform database, according to one aspect.

FIG. 7 is a block diagram illustrating a general overview of communications between the highlight processor and the production engine, according to one aspect.

FIG. 8 is a general overview of communications between the highlight processor and the parsing engine, according to one aspect.

FIG. 9 is an example of a portion of a digital publication having user inserted footnotes, according to one aspect.

FIG. 10 is an example of automatically highlighting keywords in a digital publication utilizing the system for automatically inserting multimedia and/or metadata into the digital publication, according to one aspect.

FIG. 11 is an example of a display of multimedia associated with a keyword, according to one aspect.

FIG. 12 is an example of a shared intelligent highlighting object, according to one aspect.

FIG. 13 (comprising FIGS. 13A and 13B) is a flow diagram illustrating a method for automatically inserting multimedia into a digital publication, according to one aspect.

### DETAILED DESCRIPTION

The following detailed description describes the best currently contemplated methods of carrying out the invention. This information should not be construed as an exhaustive description of the capabilities of the invention, but is provided solely for the purpose of illustrating the general principles of the invention.

In the following description, specific details are given to provide a thorough understanding of the embodiments. However, it will be understood by one of ordinary skill in the art that the embodiments may be practiced without these specific details. For example, components may be shown in block diagrams in order not to obscure the embodiments in unnecessary detail. In other instances, well-known components, structures, and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc.

### Definitions

As used herein, the following terms and variations thereof have the meanings given below, unless a different meaning is clearly intended by the context in which such term is used.

“Binary” refers to a file, which may contain any type of data, encoded in binary form for computer storage and processing purposes.

“Component” refers to a branch of software that emphasizes the separation of functions in respect of the wide-ranging functionality available throughout a given software system or a device or physical entity in an electronic system.

“Database” refers to a data structure that stores organized information in multiple tables (relational), or as objects (object oriented).

“Flag” refers to a database function, which communicates, prompts, or calls another database when database is prepared to transfer information.

“Highlighting” and “Highlight” refer to emphasizing or making prominent significant or interesting detail(s) that raise the attention of the observer.

“Keywords” refer to words or phrases that describe content. In the context of the present disclosure, keywords represent the location of where multimedia has been stored.

“Multimedia” refers to data and/or information that can sustain text, images, audio, video and/or animation. Text is structured as a sequence of lines of electronic text having formats which may include, but are not limited to, TXT, DOC, DOCM, DOCX, RFT. Audio file formats may include, but are not limited to, MP3, MP4, Advanced Audio Coding (AAC), Waveform Audio File Format (WAVE), Avid Audio eXtension (AAX), AAX+. Image file formats may include, but are not limited to, JPEG, Graphics Interchange Format (GIF), Portable Network Graphics (PNG), Bitmap (BMP), Tagged Image File Format (TIFF) and MP4. Animation and/or video footage formats may include, but are not limited to, MP4, M4V, Flash, MOV, MJEP. Animation: ANI, Extended Vector Animation (EVA), FLA, Graphics Interchange Format (GIF), and Portable Network Graphics (PNG).

“Parsing” refers to breaking up ordinary text, where programs parse text documents and extract certain data and/or information.

“Objects” refer to software objects comprising state and related behavior. An object stores its state and exposes its behavior through methods. Methods operate on an object's internal state and serve as the primary mechanism for object-to-object communications and/or functions.

“Trigger” refers to a database procedural code that is automatically executed in response to certain events on a particular table or view in a database. Triggers are used for keeping the integrity of the information in the database.

“Digital Publications” and “Electronic Publications” refer to both offline documents (documents stored or published in physical or handheld devices such as CDs and DVDs) and online documents (documents controlled by or connected to computer or to a network).

“Content” refers to digital/electronic publications and/or multimedia.

### Overview

According to one aspect of the present disclosure, an intelligent highlighting system is provided that produces electronic files for publication. The electronic files may include an electronic/digital publication, highlighted keywords, and multimedia. The intelligent highlighting system allows users, such as authors of electronic/digital publications, to upload multimedia of their choosing to a server as part of, or related to, the creation by the author of the electronic/digital publications. The multimedia may be identified, indexed and classified in order to automatically compile and embed the multimedia with keywords.

According to another aspect, the intelligent highlighting system allows an author of an electronic publication to identify words to be visually highlighted automatically in the electronic/digital publication.

According to yet another aspect, the intelligent highlighting system allows for highlighted words to be automatically populated with metadata to facilitate downstream functions, such as; authentication of ownership, publication description, and/or purchasing related information.

According to yet another aspect, the intelligent highlighting system allows an author of an electronic/digital publication to control and manipulate how the text, symbols, or multimedia are displayed when the highlighted words or symbols are selected by the user.

According to yet another aspect, the intelligent highlighting system allows an author of an electronic publication to automatically produce multimedia enhanced publications capable of being read on multiple devices using different operating systems, such as electronic readers, multipurpose tablets, and smartphones.

Using the intelligent highlighting system, multimedia may be automatically inserted into digital publications, i.e. merging digital publications with multimedia throughout a document. In the system, a highlight processor may manage a sequence of software procedures, sub-procedures, databases, pre-programmed database queries, and rule-based programs to determine what multimedia is to be inserted and where it is to be inserted into the digital publication.

In the system, a digital publication may be uploaded into a parsing engine, which parses the digital publication to identify multimedia references. That is, the parsing engine may analyze the digital text to identify any multimedia references, such as footnotes, comments, hyperlinks, URLs, or uploaded multimedia file names and extensions, that exist in the digital text. Once identified, the parsing engine may index the locations and reference data relating to, or associated with, all identified multimedia references in the publication. The reference data may include, but is not limited to, online multimedia (URL) and offline multimedia (common multimedia extensions, e.g. jpeg, mp3, or mp4). After the indexing has been completed, the reference data may then be identified and categorized. The indexed, identified and categorized locations and reference data may then be stored in a project identification database and used to identify and capture multimedia.

After storing the indexed, identified and categorized locations and reference data, multimedia may then be inserted into the digital publication by applying a default or pre-determined highlighting method, as described in further detail below. To insert the multimedia into the digital publication, the multimedia and the default or pre-determined highlighting method stored in the project identification (ID) database may be transferred to an object engine. The object engine may then compile the multimedia and highlighting method as a programmable software object, or an “Intelligent Highlighting Object”, and send to the highlight processor. The highlight processor may then automatically highlight keywords, identified by the multimedia references (i.e. footnotes, comments and hyperlinks) with Intelligent Highlighting Objects, embed a hidden multimedia path within the associated keyword or comment call out and store as a binary file type.

As each e-reader has its own specifications, the highlight processor may query a platform database for e-reader specifications for each type of device that is to receive the digital publication embedded with multimedia. The e-reader specifications, which provide the proper downstream multimedia format conversion for each e-reader, may then be stored in the project ID database.

The highlight processor may then transfer project ID data (i.e. data stored in the project ID database such as the multimedia and the pre-determined highlighting method) and the binary file to a production engine. The production engine may then convert multimedia files to appropriate formats compatible with user selected multimedia players (e.g. Apple QuickTime®, Microsoft Windows Media Player®, Real Networks RealPlayer®, and industry standard multimedia format, e.g. JPEG, GIF, BMP, TIFF, MP3, MP4, AAC, WAV, AAX, AAX+, AIFF, M4V, FLASH, MOV, MJPEG). Once the multimedia files have been converted, the production engine may then produce multiple versions of the digital publications embedded with multimedia that is compatible with specified devices (i.e. e-readers).

### Intelligent Highlighting System

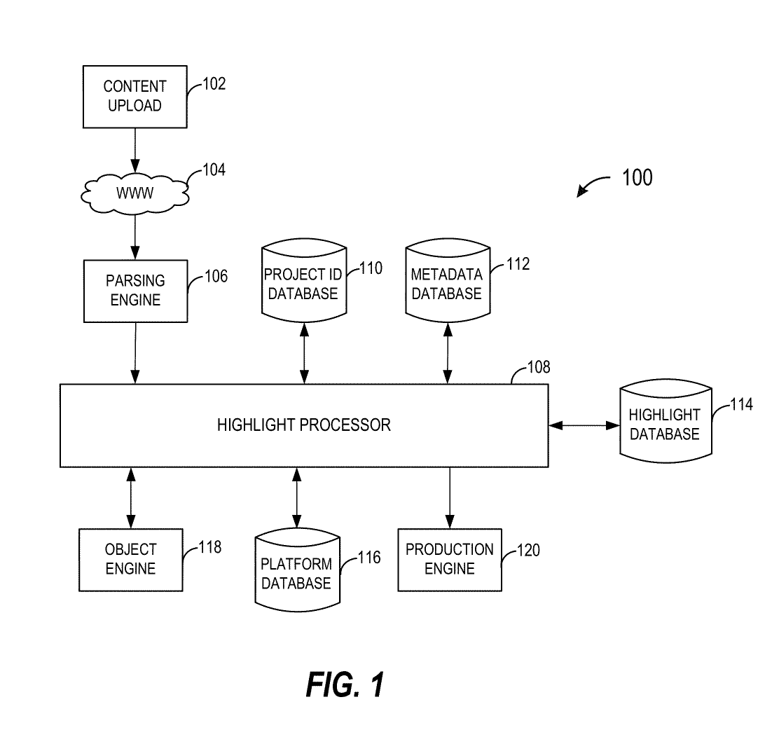

FIG. 1 is a block diagram illustrating a general overview of an intelligent highlighting system 100 according to one aspect. In the system 100, automated procedures may be utilized to automatically insert multimedia into digital publications. For example, digital text may be merged with multimedia throughout a document. Digital publications may include, but are not limited to books, magazines, catalogues, newsletters and any other type of publication.

The automated procedures may include detecting “keywords” within a digital publication having a path or link to associated multimedia. Once keywords have been identified, a Highlight Processor (HP) may automatically highlight keywords in the digital publication and embed related multimedia files within the keyword(s). Multimedia files can be opened by clicking on the highlighted keyword(s) when displayed on appropriate digital devices, e.g. electronic readers, multipurpose tablets, and smartphones. According to one aspect, two highlighting methods may be applied, “Cosmetic” or “Intelligent.” Cosmetic highlighting may change the appearance of the keyword in order to alert the reader that multimedia is present while intelligent highlighting may provide a visual alert to the reader. Intelligent highlighting may contain multimedia encapsulated within software program “objects”, described in more detail below, to facilitate various downstream services and functions.

As shown in FIG. 1, content 102, such as digital publications and multimedia, may be uploaded to a parsing engine 106 which may systematically identify footnotes, comments, or hyperlink locations as well as any associated multimedia path(s) located in a footnote reference footer, comment callout, or hyperlink path within the uploaded content. According to one aspect, the content may be uploaded via the Internet (WWW) 104. As described above, the uploaded content 102 may utilize various text file formats, for example, TXT, DOC, DOCM, DOCX, RFT, and associated multimedia formats, e.g. Images: JPEG, Graphics Interchange Format (GIF), Portable Network Graphics (PNG), Bitmap (BMP), Tagged Image File Format (TIFF), MP3. Audio: MP3, MP4, Advanced Audio Coding (AAC), Waveform Audio File Format (WAVE), Avid Audio eXtension (AAX), AAX+. Video: MP4, M4V, Flash, MOV, MJEP. Animation: ANI, Extended Vector Animation (EVA), FLA, GIF, and PNG.

According to one aspect, after the content 120 has been uploaded, the parsing engine 106 may index (or categorize) the relationship between the word preceding (i.e. a keyword) a footnote, comment callout, or hyperlink, and the associated multimedia file path. Next, the parsing engine 106 may convert the text file to an HTML5 format. Once the conversion of the text file to HTML5 format has been completed, the parsing engine 106 may flag or communicate the completion of the conversion to a highlight processor 108. In accordance with one aspect, the highlight processor 108 may serve as a central component for collecting, routing, storing and processing data throughout the production process and be comprised of software routines which provoke and/or respond to the execution of production software routines when flagged or triggered by subcomponents, described below, of the system. The software may reside on a master server (computer) or servers (computers).

Flagging the highlight processor 108 may trigger the highlight processor 108 to extract the results from the parsing engine 106 and store the results in a project identification (ID) database 110. In accordance with one aspect, the project ID database 110 may serve as a central database, managed by the highlight processor 108, for storing all relevant data throughout the production process. Relevant data may refer to, for example, parsing results, highlighting method of choice, multimedia collection results, and device types of choice, e.g. Apple iPad®, Kindle Fire®, etc.

In addition to the project ID database 110, the system may also include databases for storing digital text, multimedia and reference information, and modules (or engines) for performing a function on data. According to one aspect, the system may include a metadata database 112, populated by a user, for storing information describing the uploaded content, e.g. a digital publication. Metadata is a term that describes other data by providing information about content. For example, content in the form of an image may include metadata that describes how large the picture is, the image resolution, when the image was created, and other data while content in the form of text may contain information about how long the document is, who the author is, when the document was written, and a short summary of the document. According to one aspect, the information about the content stored in the metadata database 112 may include, but is not limited to; title, author's name, International Standard Book Number (ISBN), copyright date, and/or information, or links to identify where to purchase the publication, referred to as Point Of Sale (POS) throughout the system.

The system may also include a highlight database 114, which may serve as a repository for different structural and aesthetic variations used to highlight keywords. For example, keywords located within the content may have a specific font type, a translucent overlay, a specific background color, or icon. The method for highlighting the keywords may be selected by the user during the production process, as described in further detail below. Highlighted keywords may be identified by the highlight processor 108 and stored in the project ID database 110.

An object engine 116, in communication with the highlight processor 108, may be used to create programmable objects for storage in the project ID database 110. Programmable objects may contain the selected highlighting method and metadata. Intelligent highlighting objects may present metadata when an excerpt from a digital publication is copied and shared via the Internet or other communication network. Metadata may be presented, in addition to the copied excerpt, in order to provide the recipient with various forms of information. Such information may include, but is not limited to, title, author's name, ISBN, copyright date, and/or information, or links to identify where to purchase the publication (POS).

The system may also include a platform database 118 for storing manufacturer device specifications and supported multimedia formats for each device such as; MP3, WAV, MP4, OGG, Musical Instrument Digital Interface (MIDI). Based on the user selected devices of choice stored in the project ID database 110, the highlight processor 108 may query the platform database 118 which returns the required multimedia formats for each selected device and stores the information in the project ID database 110.

A production engine 120 may receive the manufacturer device specifications and supported multimedia formats for each device as well as the binary version of the publication. Using this information, the production engine 120 may then convert default multimedia contained within the binary version of the publication to multimedia formats supported by the devices as specified by the platform database 118.

Next, the highlight processor 108 may provide instructions for compiling the results and systematically highlighting keywords, embedding metadata, and embedding a multimedia path within highlighted keywords to produce a binary version of the publication. The binary version of the publication may be transmitted to the production engine 120 for producing multiple versions of the enhanced publication compatible with user selected devices of choice, e.g. electronic readers, multipurpose tablets, and smartphones.

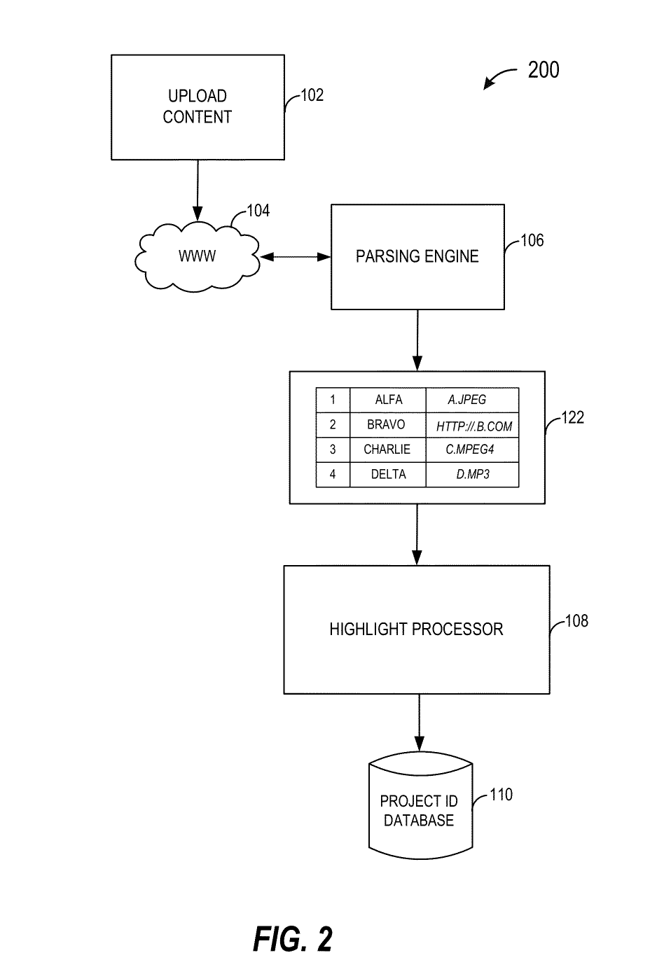

FIG. 2 is a block diagram illustrating a general overview 200 of parsing uploaded content, according to one aspect. As shown, content 102, such as digital publications and/or multimedia, may be uploaded, via the Internet (WWW) 104, to the parsing engine 106. The parsing engine 106 may parse the uploaded content and identify any footnotes, comments and hyperlinks within the content and capture reference data. Results 122 of the parsing of the content may be sent to a highlight processor 108. According to one aspect, the parsing results 108 may be in the form of a database index table. In one example, the database index table may comprise three columns, a first column identifying the footnote number (#), a second column identifying the uploaded multimedia file name and a third column identifying the extension, URL, or hyperlink of the uploaded multimedia file. The parsing results may then be stored in the project ID database 110.

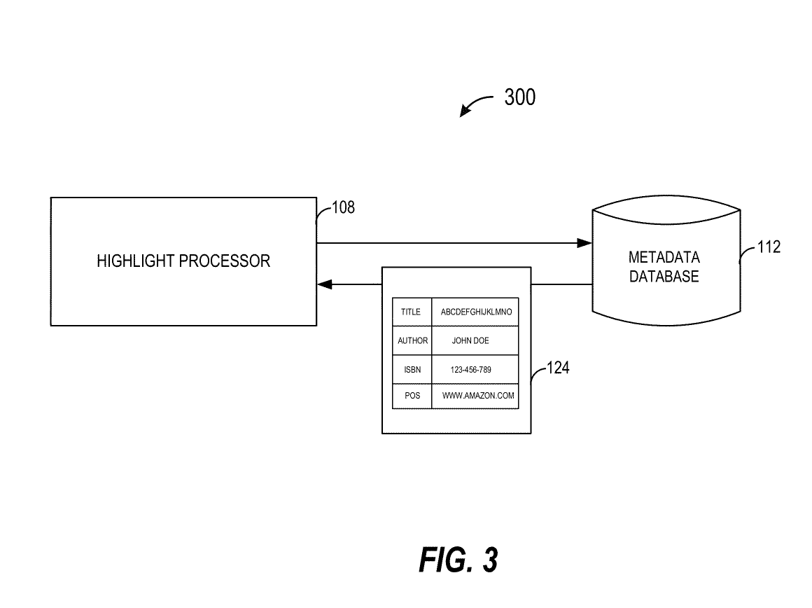

FIG. 3 is a block diagram illustrating a general overview 300 of communications between the highlight processor 108 and the metadata database 112, according to one aspect. As shown, the highlight processor 108 may be in communication with the metadata database 112. When enhancing or embedding digital publications with multimedia, the highlight processor 108 may send a query to the metadata database 112 to determine if metadata specific to the parsing results stored in the project ID database 110 exist. If metadata is identified, the metadata database 112 may send the appropriate metadata to the project ID database 110 for storage. According to one aspect, the metadata may be provided in the form of a database index table 124. In one example, the database index table 124 may comprise four rows, a first row identifying the title, a second row identifying the author, a third row identifying an ISBN number and a fourth row identifying the Point Of Sale (POS).

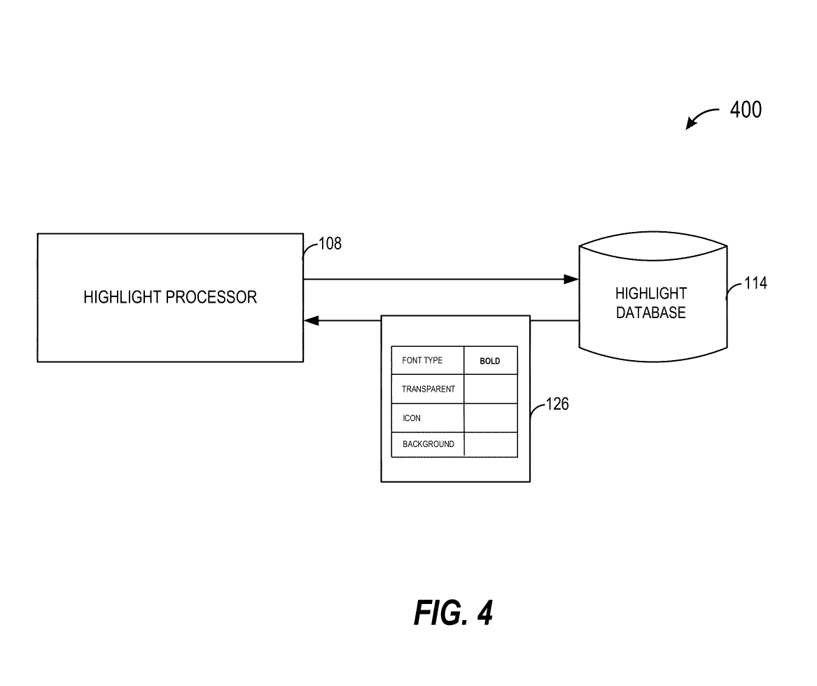

FIG. 4 is a block diagram illustrating a general overview 400 of communications between the highlight processor 108 and the highlight database 114, according to one aspect. As shown, the highlight processor 108 may query the highlight database 114 for obtaining the highlighting method selected by the user. In response to the query, the highlight database 114 may provide the user selected highlighting method 126 to the highlight processor 108. The highlight processor 108 may then store the selected highlighting method in the project ID database 110.

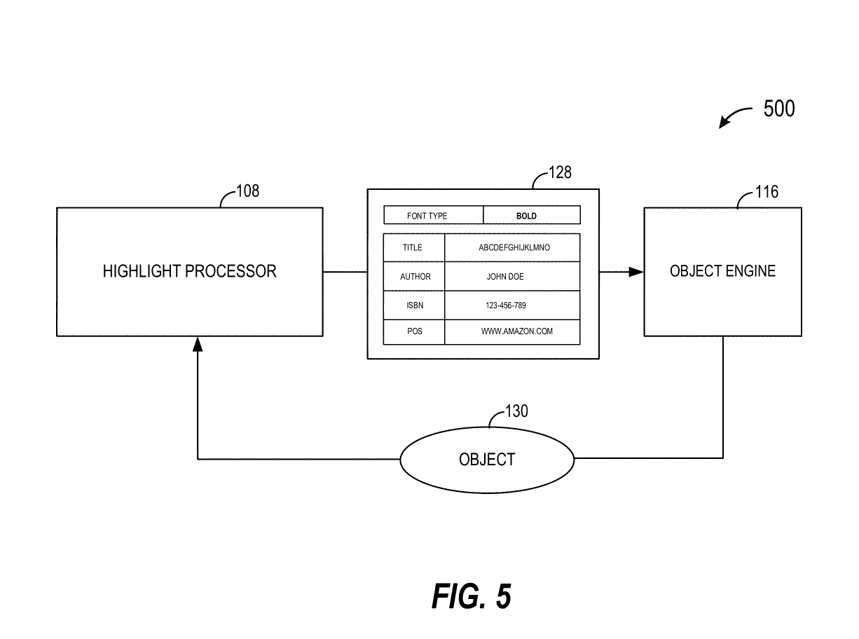

FIG. 5 is a block diagram illustrating a general overview 500 of communications between the highlight processor 108 and the object engine 116, according to one aspect. As shown, the highlight processor 108 may be in communication with and provide the object engine 116 with data stored in the projected ID database 110. The object engine 116 may package the data as a programmable software object 130 containing metadata as well as the user selected highlighting method and then return the object 130 to the highlight processor 108.

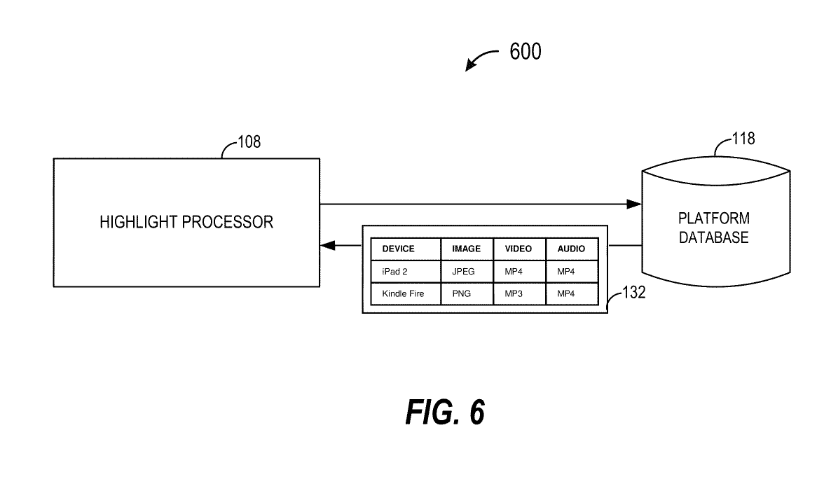

FIG. 6 is a block diagram illustrating a general overview 600 of communications between the highlight processor 108 and the platform database 118, according to one aspect. As shown, the highlight processor 108 may be in communication with the platform database 118. When enhancing the uploaded content, the processor 108 may query the platform database 118 for user-selected devices. The platform database 118 may identify and return the device brand, model, and supported multimedia formats in the form of a database index table 132.

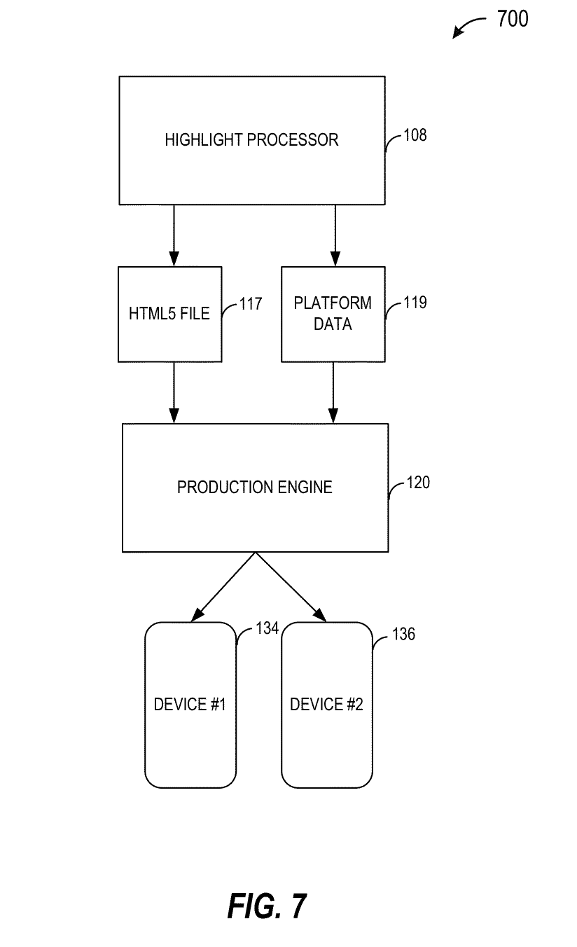

FIG. 7 is a block diagram illustrating a general overview 700 of communications between the highlight processor 108 and the production engine 120, according to one aspect. The highlight processor 108 may convert enhanced digital publication to a HTML5 file 117 and pass to the production engine 120, in addition to a subset of the project ID database, i.e. platform database profile (or platform data) 119, populated by the device database results. Device database results may include various versions of the publication where multimedia has been converted to appropriate file types supported by the “target” devices, e.g. iPad®, Kindle®, etc.

Next, the production engine 120 may identify different multimedia format types as compared to default multimedia formats contained within the HTML5 of the publication. Once identified, production engine 120 may then convert format types to supported devices 134, 136 as specified in the platform database 118 results, and produce multiple versions of the publication compatible with all devices selected by the user.

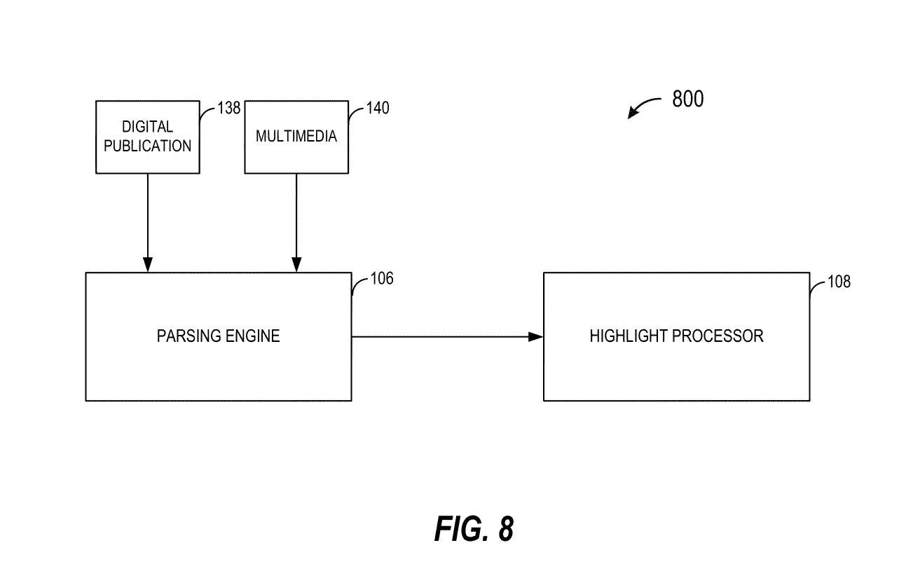

FIG. 8 is a general overview 800 of communications between the highlight processor 108 and the parsing engine 106, according to one aspect. The parsing engine 106 may analyze digital publications 138 to identify where multimedia references, such as hyperlinks, URLs or uploaded multimedia file names and extensions, exist. Once analyzed, keyword(s) may be automatically highlighted with a default method, which can be changed by the user in the review and editing stages in production. Additionally, the parsing engine 106 may automatically embed multimedia 140 within the keyword(s) and the embedded digital publication may be converted to HTML5 script and passed to the highlight processor 108.

As described above, the highlight processor 108 may serve as the central component that collects, routes, processes and stores analysis results throughout the production process. The highlight processor 108 may also analyze data to identify anomalies, i.e. the number of multimedia references versus the number of file types as well as post pre-scripted error messages (alerts) to a user interface in the event that any anomalies have been identified. Anomaly free files may be saved and passed to the project ID database 112.

As described above, the system may also include one or more subcomponents, such as the project ID database 110, the metadata database 112, the object engine 118, the platform database 116 and the production engine 120.

The project ID database 110 may systematically apply a unique identification (ID) number to each project upon receipt of parsing results from the highlight processor 108. Additionally, the project ID database 110 may store all project results from the system components in a relational database structure provided by the highlight processor 108, i.e. the parsing engine, metadata database, highlight database, object engine and platform database.

The metadata database 112 may store all input provided by the user to identify various aspects of the publication, e.g. title, author, publisher, language, ISBN number, genre, sub-genre, geographic premise, time table setting, character demographics, reference to similar publications based on plot, key words to locate publication online.

The highlight database 114 may store the various methods that can be used for highlighting keywords, e.g. font type, background color, translucent overlay, multimedia icon, or buttons as well as the user selected highlighting method. As described above, the user may select a preferred method of highlighting. To obtain this preferred method, the highlight processor 108 may query the highlight database 114 to obtain the user-selected method and then send the selected highlighting method, along with the applied metadata, to the object engine 118. The object engine 118 may then generate a programmable software object constructed of JAVA scripts, which encapsulates the highlight method and metadata. Once constructed, the object engine 118 may then send the programmable software object to the highlight processor 108.

The platform database 116 may store all input provided by the user to identify selected devices, e.g. Apple iPad®, Kindle Fire®, Samsung Galaxy®. When queried by the highlight processor 108, the platform database 116 may provide the highlight processor 108 with data containing specifications for every device chosen in preparation for downstream multimedia format conversion.

The highlight processor 108 may pass the publication, constructed as an HTML5 file, and the platform database profile (or platform data) to the production engine 120. The production engine 120 may then convert multimedia files to compatible file types based on the platform database specifications and produce multiple versions of the publication applicable to the selected devices.

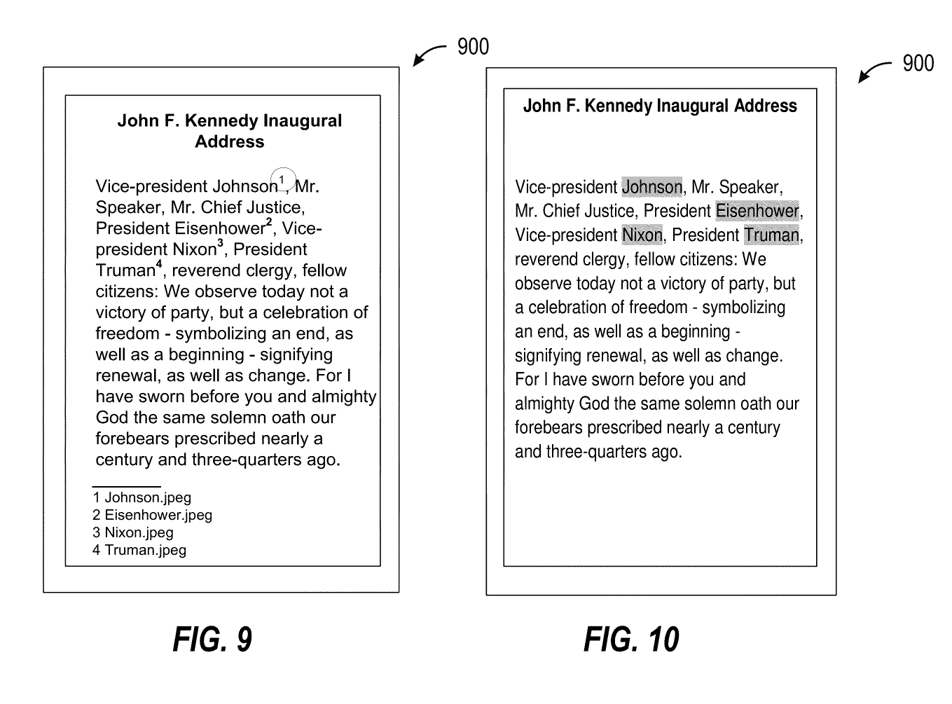

FIG. 9 is an example of a portion of a digital publication 900 having user inserted footnotes, according to one aspect. As shown, the digital publication is the beginning of John F. Kennedy's Inaugural Address, which acknowledges some of the dignitaries present at the Inauguration. Each of the identified dignitaries has been selected as a “keyword” and a unique footnote number has been inserted by the user after each “keyword”. Each footnote may then be associated with a multimedia file name or path in the reference footer of digital content.

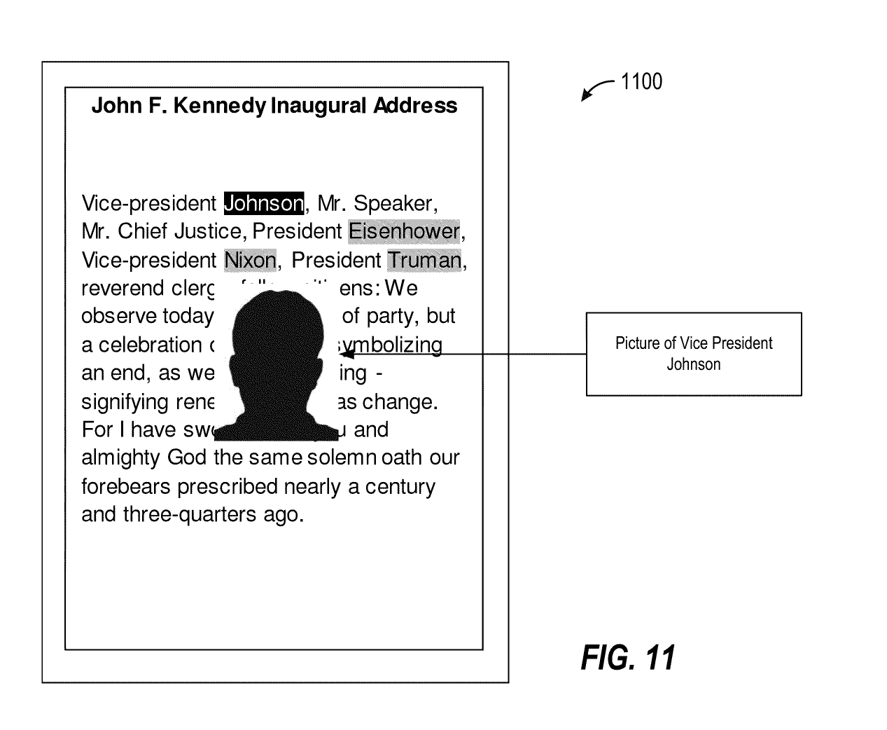

FIG. 10 is an example of automatically highlighting keywords in the digital publication 900 in FIG. 9 utilizing the system for automatically inserting multimedia and/or metadata into the digital publication, according to one aspect. In place of a footnote, each keyword may be automatically highlighted; using the user selected highlighting method, indicating that the keywords are associated with multimedia content.

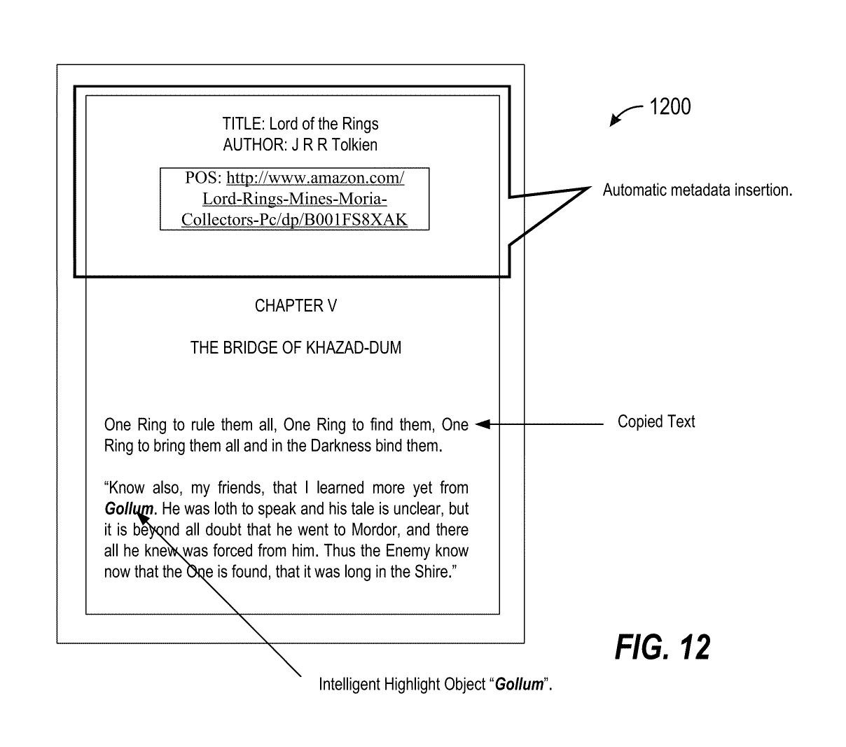

FIG. 11 is an example of a display of multimedia 1100 associated with a keyword, according to one aspect. To access the multimedia, a user may click, or tap, on the keyword(s). As shown, if the keyword “Johnson” is selected, a picture of Vice President Johnson is displayed. This visual multimedia may be presented as a layer above the body of the text. According to one aspect, the visual multimedia may be viewed in a full screen mode by double tapping or clicking the multimedia window and may be closed with a single tap or click.

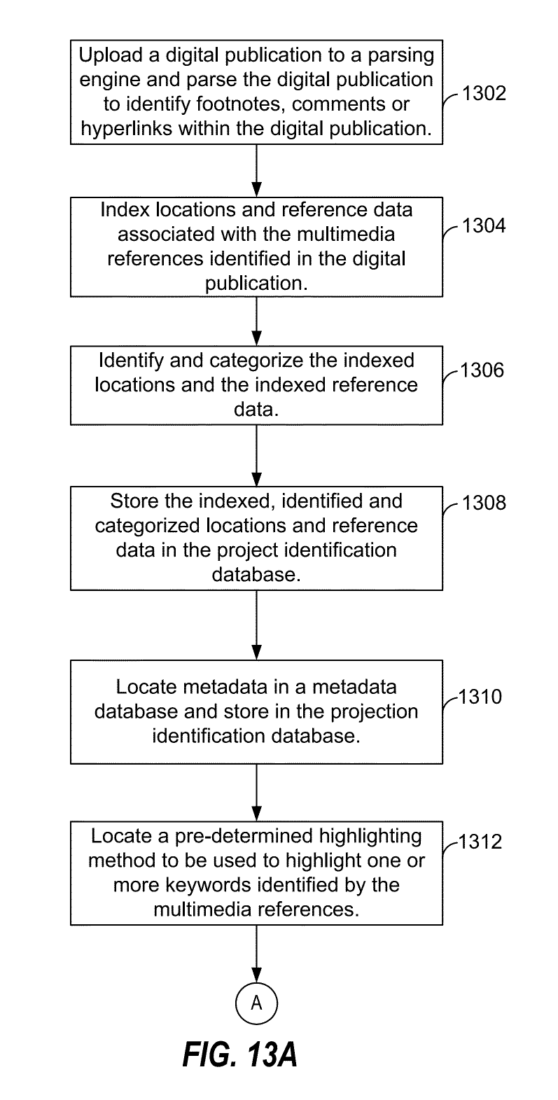

FIG. 12 is an example of shared intelligent highlighting object 1200, according to one aspect. When intelligent highlighting objects are copied and shared, the programmable objects created by the object engine 116 may automatically insert information (metadata) such as; the publication title (Lord of the Rings), author's name (J R R Tolkien), place of purchase information (Amazon), chapter containing the copied content (Chapter V), and title of the chapter (The Bridge of Khazad-dum).

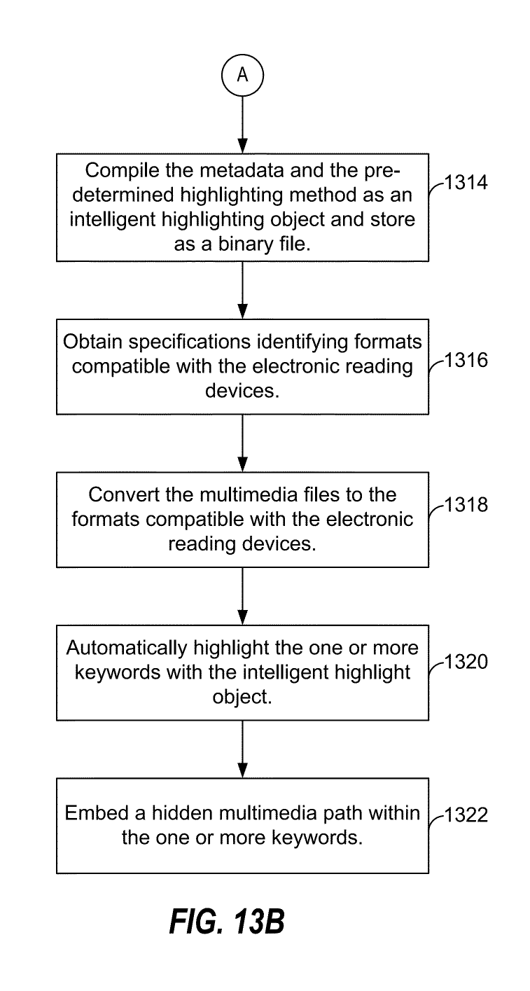

FIG. 13 (comprising FIGS. 13A and 13B) is a flow diagram illustrating a method for automatically inserting multimedia into digital publications according to one aspect. First, a digital publication may be uploaded to a parsing engine for parsing the digital publication to identify media references, such as footnotes, comments, or hyperlinks within the digital publication 1302. Next, locations and reference data associated with the media references identified in the digital publication may be indexed 1304. The indexed locations and the indexed reference data may be identified and categorized for identifying and capturing multimedia 1306. The indexed, identified and categorized locations and reference data may then be stored in the project identification database 1308.

Next, metadata specific to the identified media references may be obtained or located from the metadata database and stored in the project identification database 1310 and a pre-determined highlighting method to be used for highlighting one or more keywords identified by the media references may be located/obtained 1312. Next, the metadata and the pre-determined highlighting method may be compiled as an intelligent highlighting object and stored as a binary file 1314. Specifications identifying formats compatible with the electronic reading devices may be obtained 1316 and then the media files may be converted to the formats compatible with the electronic reading devices 1318. The one or more keywords may be automatically highlighted with the intelligent highlighting object 1320 and a hidden multimedia path may be embedded within the one or more keywords 1322.

One or more of the components and functions illustrated in the figures may be rearranged and/or combined into a single component or embodied in several components without departing from the invention. Additional elements or components may also be added without departing from the invention.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable storage medium”, “computer-readable storage medium”, and/or “processor-readable storage medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, micro controller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. A method of automatically inserting multimedia files into a digital publication comprising:
parsing the digital publication to identify multimedia references within the digital publication;
indexing locations and reference data associated with the multimedia references identified in the digital publication;
identifying and categorizing the indexed locations and the indexed reference data, the indexed, identified and categorized locations and reference data used to identify and capture multimedia; and
storing the indexed, identified and categorized locations and reference data in a project identification database.

2. The method of claim 1, further comprising:
locating metadata stored in a metadata database; and
storing the metadata in the project identification database.

3. The method of claim 2, further comprising:
located a pre-determined highlighting method used to highlight one or more keywords, the one or more keywords identified by the multimedia references;
compiling the metadata and the pre-determined highlighting method as an intelligent highlighting object; and
storing the compiled metadata and pre-determined highlighting method as a binary file.

4. The method of claim 3, further comprising:
determining specifications of one or more electronic reading devices, the specifications including one or more formats compatible with the one or more electronic reading devices; and
converting the multimedia files to one or more formats compatible with the one or more electronic reading devices.

5. The method of claim 4, further comprising:
automatically highlighting the one or more keywords with the intelligent highlighting object; and
embedding a hidden multimedia path within the one or more keywords.

6. The method of claim 1, wherein the multimedia references include at least one of a footnote, comment and hyperlink.

7. The method of claim 1, wherein the reference data is selected from at least one of online multimedia and offline multimedia, and wherein the online multimedia is a URL and the offline multimedia is a multimedia extension.

8. The method of claim 2, wherein the metadata includes at least one of a title, an author's name, an International Standard Book Number (ISBN), a copyright date, and information of where to purchase the publication.

9. The method of claim 3, wherein the pre-determined highlighting method is a cosmetic highlighting method, the cosmetic highlighting method changes an appearance of the one or more keywords.

10. The method of claim 2, wherein the pre-determined highlighting method is an intelligent highlighting method, the intelligent highlighting method provides a visual alert.

11. A system for automatically inserting multimedia files into a digital publication, comprising:
at least one processor;
a project identification database coupled to the at least one processor; and
a metadata database coupled to the at least one processor;
wherein the at least one processor is configured to:
parse the digital publication to identify multimedia references within the digital publication;
index locations and reference data associated with the multimedia references identified in the digital publication;
identify and categorize the indexed locations and the indexed reference data, the indexed, identified and categorized locations and reference data used to identify and capture multimedia; and
store the indexed, identified and categorized locations and reference data in the project identification database.

12. The system of claim 11, wherein the at least one processor is further configured to:
locate metadata stored in a metadata database; and
store the metadata in the project identification database.

13. The system of claim 12, wherein the at least one processor is further configured to:
locate a pre-determined highlighting method used to highlight one or more keywords, the pre-determined highlighting method stored in the project identification database and the one or more keywords identified by the multimedia references;
compile the metadata and the pre-determined highlighting method as an intelligent highlighting object; and
store the compiled metadata and pre-determined highlighting method as a binary file.

14. The system of claim 13, wherein the at least one processor is further configured to:
determine specifications of one or more electronic reading devices, the specifications including one or more formats compatible with the one or more electronic reading devices; and
convert the multimedia files to one or more formats compatible with the one or more electronic reading devices.

15. The system of claim 14, wherein the at least one processor is further configured to:
automatically highlighting the one or more keywords with the intelligent highlighting object; and
embed a hidden multimedia path within the one or more keywords.

16. The system of claim 11, wherein the multimedia references include at least one of a footnote, comment and hyperlink.

17. The system of claim 11, wherein the reference data is selected from at least one of online multimedia and offline multimedia, and wherein the online multimedia is a URL and the offline multimedia is a multimedia extension.

18. The system of claim 12, wherein the metadata includes at least one of a title, an author's name, an International Standard Book Number (ISBN), a copyright date, and information of where to purchase the publication.

19. The system of claim 13, wherein the pre-determined highlighting method is a cosmetic highlighting method, the cosmetic highlighting method changes an appearance of the one or more keywords.

20. The system of claim 12, wherein the pre-determined highlighting method is an intelligent highlighting method, the intelligent highlighting method provides a visual alert.
